(19) United States
(12) Patent Application Publication
(10) Pub. No.: US 2019/0339362 A1
(43) Pub. Date: Nov. 7, 2019

(54) SIGNATURE-BASED OBJECT DETECTION METHOD AND ASSOCIATED APPARATUS

(71) Applicant: MEDIATEK INC., Hsin-Chu (TW)

(72) Inventors: Po-Chung Hsiao, Hsin-Chu (TW); Bao-Chi Peng, Hsin-Chu (TW); Li-Ming Wei, Hsin-Chu (TW)

(21) Appl. No.: 16/402,173

(22) Filed: May 2, 2019

Related U.S. Application Data
(60) Provisional application No. 62/666,192, filed on May 3, 2018.

(51) Int. Cl. G01S 7/41; G06K 9/00; G06K 9/46

(52) U.S. Cl. CPC G01S 7/41; G06K 9/4604; G06K 9/00791

(57) ABSTRACT

An object detection method includes: obtaining sensor detection inputs generated at different positions and different timestamps for a swept area of object detection, where each of the sensor detection input is generated at one of the different locations and one of the different timestamps; collecting spatio-temporal data according to the sensor detection inputs; stitching the spatio-temporal data to generate a spatio-temporal image; performing signature extraction upon the spatio-temporal image to generate a signature extraction result; and identifying a contour of the swept area according to the signature extraction result.

### CROSS REFERENCE TO RELATED APPLICATIONS

This application claims the benefit of U.S. provisional application No. 62/666,192, filed on May 3, 2018 and incorporated herein by reference.

### BACKGROUND

The present invention relates to object detection, and more particularly, to a signature-based object detection method and an associated apparatus.

A Radio Detection and Ranging (radar) system refers to electronic equipment that detects the presence of objects by using reflected electromagnetic energy. Specifically, the electronic principle on which the radar system operates is very similar to the principle of sound-wave reflection. The radar system uses electromagnetic energy pulses that are transmitted to and reflected from the reflecting objects. A small portion of the reflected energy returns to the radar system, where this returned energy is called an echo or return. Under some conditions, the radar system can use the echoes/returns to measure the direction, distance, and/or speed of the reflecting objects. The radar system may be used for empty space detection. However, a radar sensor with a wide field of view (FOV) and no angle information has difficulty in carving out edges of detected objects. The difficulty lies in the angle ambiguity of positions. Considering a case where an object is detected at a range without angle information, the detected object with the range may be regarded as being located at an arbitrary angle. To put it simply, a position of the detected object in the space cannot be exactly identified due to lack of angle information. This makes it unsuitable for empty space detection.

Thus, there is a need for an innovative object detection design which enables a radar sensor with a wide FOV and no angle information to identify edges of detected objects. For example, the innovative object detection design enables a radar sensor with a wide FOV and no angle information to achieve empty space detection.

### SUMMARY

One of the objectives of the claimed invention is to provide a signature-based object detection method and an associated apparatus.

According to a first aspect of the present invention, an exemplary object detection method is disclosed. The exemplary object detection method includes: obtaining a plurality of sensor detection inputs generated at different positions and different timestamps for a swept area of object detection, wherein each of the sensor detection input is generated at one of the different locations and one of the different timestamps; collecting spatio-temporal data according to the sensor detection inputs; stitching the spatio-temporal data to generate a spatio-temporal image; performing signature extraction, by a processing circuit, upon the spatio-temporal image to generate a signature extraction result; and identifying a contour of the swept area according to the signature extraction result.

According to a second aspect of the present invention, an exemplary object detection apparatus is disclosed. The exemplary object detection apparatus includes a wireless receiver and a processing circuit. The wireless receiver is arranged to generate a plurality of sensor detection inputs at different positions and different timestamps for a swept area of object detection, wherein each of the sensor detection input is generated at one of the different locations and one of the different timestamps. The processing circuit is arranged to obtain the sensor detection inputs, collect spatio-temporal data according to the sensor detection inputs, stitch the spatio-temporal data to generate a spatio-temporal image, perform signature extraction upon the spatio-temporal image to generate a signature extraction result, and identify a contour of the swept area according to the signature extraction result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an object detection apparatus according to an embodiment of the present invention.

FIG. 2 is a flowchart illustrating a signature-based object detection method according to an embodiment of the present invention.

FIG. 3 is a diagram illustrating a data processing scheme for spatio-temporal image generation according to an embodiment of the present invention.

FIG. 4 is a diagram illustrating a data processing scheme for signature-based empty space detection according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

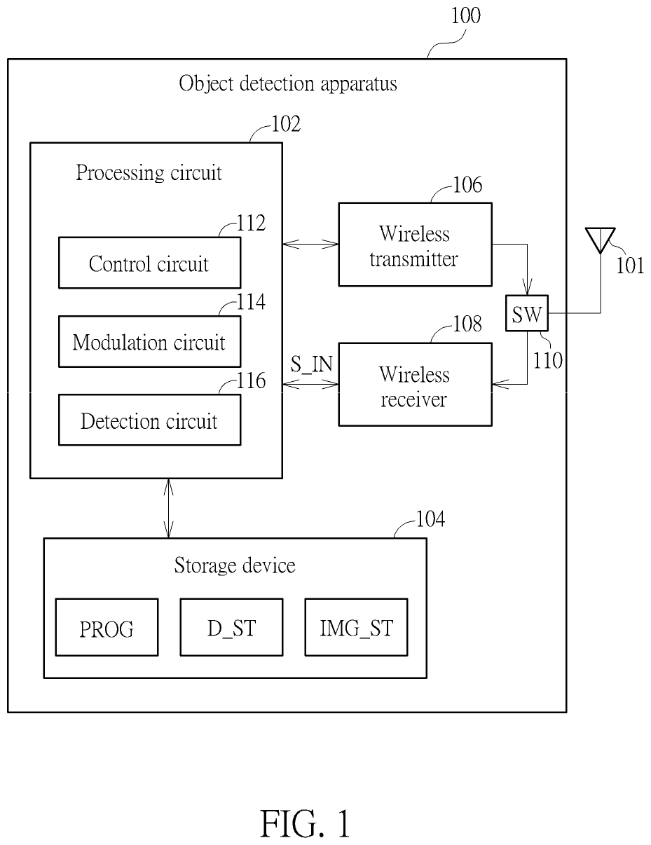

FIG. 1 is a diagram illustrating an object detection apparatus according to an embodiment of the present invention. For example, the object detection apparatus 100 may be a radar system such as an automotive radar system. For another example, the object detection apparatus 100 may be a single radar sensor equipped with multiple-object reporting capability and/or only a single antenna. However, this is not meant to be a limitation of the present invention. Any object detection apparatus using the proposed signature-based object detection technique falls within the scope of the present invention. For clarity and simplicity, the following assumes that the object detection apparatus 100 is a radar system using only a single radar sensor that is equipped with multiple-object reporting capability and/or only a single antenna. In other words, the terms “object detection apparatus” and “radar system/sensor” may be interchangeable. As shown in FIG. 1, the object detection apparatus 100 includes a processing circuit 102, a storage device 104, a wireless transmitter 106, a wireless receiver 108, and a switch circuit (denoted by “SW”) 110. The processing circuit 102 includes a control circuit 112, a modulation circuit 114, and a detection circuit 116.

The control circuit 112 is arranged to control operations of the object detection apparatus 100. For example, the wireless transmitter 106 and the wireless receiver 108 may share the same off-chip antenna (e.g., single antenna 101) through the switch circuit 110 under the control of the control circuit 112. Specifically, the switch circuit 110 is a transmit/receive (TR) switch that is capable of alternately connecting the wireless transmitter 106 and the wireless receiver 108 to the shared antenna 101. When the object detection apparatus 100 operates under a transmit (TX) mode, the control circuit 112 may turn off the wireless receiver 108, and may further instruct the switch circuit 110 to couple an output port of the wireless transmitter 106 to the antenna 101. When the object detection apparatus 100 operates under a receive (RX) mode, the control circuit 112 may turn off the wireless transmitter 106, and may further instruct the switch circuit 110 to couple an input port of the wireless receiver 108 to the antenna 101.

In a case where the processing circuit 102 is a digital circuit, the wireless transmitter 106 may include a digital-to-analog converter (not shown) for converting a digital baseband output of the processing circuit 102 into an analog baseband input for undergoing up-conversion, and the wireless receiver 108 may include an analog-to-digital converter (not shown) for converting an analog baseband output of down-conversion into a digital baseband input of the processing circuit 102 for further processing.

Modulation techniques play a key role in the radar technology. The mode of transmission makes a huge difference in the performance of the radar system and hence the technique will change as per the application. The two most commonly used techniques are Frequency Modulated Continuous wave (FMCW) and the Pulsed Doppler technique. FMCW is commonly used in industrial applications as well as automotive applications, while in military applications, the Pulsed Doppler is widely accepted. In this embodiment, the modulation circuit 114 is arranged to deal with modulation under the TX mode.

The detection circuit 116 is arranged to deal with demodulation and target detection under the RX mode. In accordance with the proposed signature-based object detection design, the detection circuit 116 is further arranged to deal with signature extraction (e.g., geometry signature extraction). Further details of the proposed signature-based object detection design are described as below with reference to the accompanying drawings.

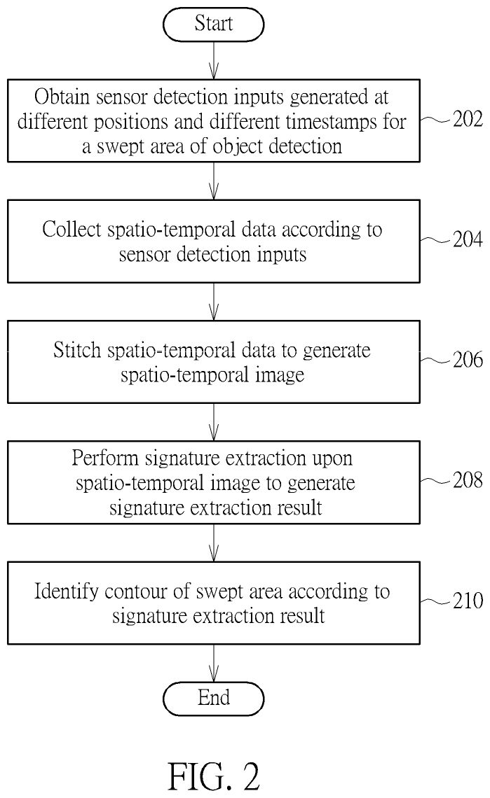

FIG. 2 is a flowchart illustrating a signature-based object detection method according to an embodiment of the present invention. The signature-based object detection method may be employed by the object detection apparatus 100 (particularly, detection circuit 116 shown in FIG. 1). At step 202, the detection circuit 116 obtains a plurality of sensor detection inputs S_IN that are received by the wireless receiver 108 at different positions and different timestamps for a swept area of object detection. At step 204, the detection circuit 116 collects spatio-temporal data D_ST according to the sensor detection inputs S_IN generated from the wireless receiver 108. For example, the collected spatio-temporal data D_ST may be buffered in the storage device 104. At step 206, the detection circuit 116 stitches/assembles the spatio-temporal data D_ST to generate a spatio-temporal image IMG_ST for the swept area of object detection. For example, the detection circuit 116 may read the spatio-temporal data D_ST from the storage device 104, and may store the created spatio-temporal image IMG_ST into the storage device 104 for further processing.

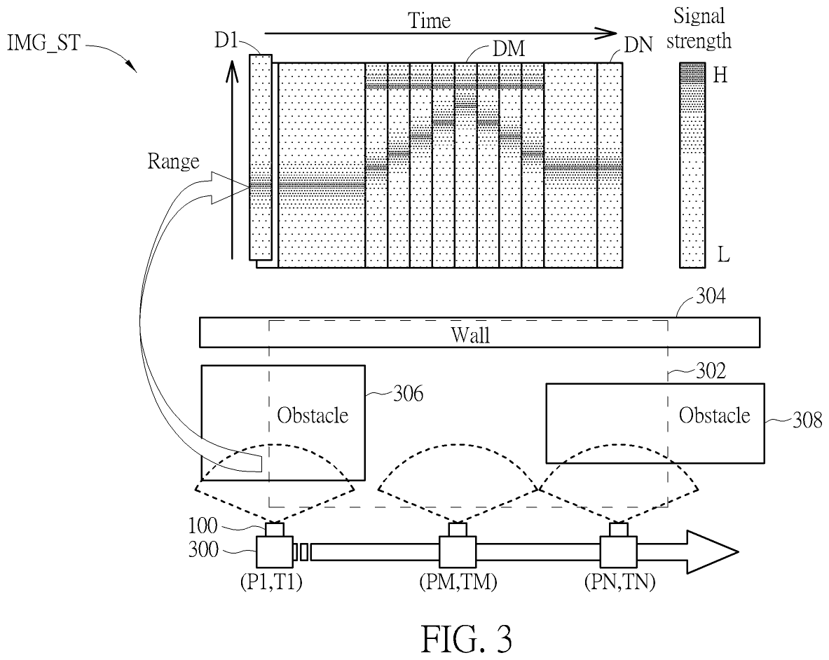

FIG. 3 is a diagram illustrating a data processing scheme for spatio-temporal image generation according to an embodiment of the present invention. In this embodiment, the object detection apparatus 100 maybe a single radar sensor mounted on a fixture 300. For example, the object detection apparatus 100 is an automotive radar sensor, and the fixture 300 is a part of an automobile. As shown in FIG. 3, the object detection apparatus 100 (e.g., automotive radar sensor) sweeps an area 302 while moving in a straight line. Hence, the object detection apparatus 100 (particularly, wireless receiver 108) generates sensor detection inputs S_IN at different positions and different timestamps. For example, one sensor detection input S_IN is generated at the timestamp T1 when the object detection apparatus 100 is located at the position P1, another sensor detection input S_IN is generated at the timestamp TM when the object detection apparatus 100 is located at the position PM, and yet another sensor detection input S_IN is generated at the timestamp TN when the object detection apparatus 100 is located at the position PN. After receiving the sensor detection inputs S_IN from the wireless receiver 108, the detection circuit 116 collects associated spatio-temporal data D_ST according to the received sensor detection inputs S_IN. That is, the detection circuit 116 collects data over time while the fixture 300 on which the object detection apparatus 100 is mounted is moving. For example, the detection circuit 116 derives one spatio-temporal data D1 from one sensor detection input generated at position P1 and timestamp T1, derives another spatio-temporal data DM from another sensor detection input generated at position PM and timestamp TM, and derives yet another spatio-temporal data DN from yet another sensor detection input generated at position PN and timestamp TN.

In this embodiment, the object detection apparatus 100 is a single wide-FOV radar sensor equipped with multiple-object reporting capability and single antenna 101. Further, each spatio-temporal data gives signal strength of different ranges. As shown in FIG. 3, the highest signal strength H is represented by dots with the highest density, and the lowest signal strength L is represented by dots with the lowest density. Since the object detection apparatus 100 is a multiple-object reporting wide-FOV radar sensor, one spatio-temporal data collected at one of different positions and one of different timestamps may have multiple high signal strength regions due to multiple objects existing at different ranges. As shown in FIG. 3, one wall 304 and two obstacles 306 and 308 co-exist in the swept area 302 of objection detection. When the fixture 300 is at the position P1, the spatio-temporal data D1 collected at timestamp T1 has one high signal strength region resulting from the obstacle 306. When the fixture 300 moves to the position PN, the spatio-temporal data DN collected at timestamp TN has one high signal strength region resulting from the near-end obstacle 306 and another high signal strength region resulting from the far-end wall 304. Since the object detection apparatus 100 is a radar sensor with a wide FOV, one spatio-temporal data collected at a timestamp and a position may have at least one high signal strength region resulting from at least one object located directly in front of the object detection apparatus 100 and may further have at least one high signal strength region resulting from at least one object that is not located directly in front of the object detection apparatus 100. For example, when the fixture 300 is at the position PM (P1<PM<PN), the spatio-temporal data DM collected at the timestamp TM (T1<TM<TN) has one high signal strength region resulting from the wall 304 (which is directly in front of the object detection apparatus 100) and another high signal strength region resulting from the nearby obstacle 306/308 (which is not directly in front of the object detection apparatus 100).

In above embodiment, each spatio-temporal data gives signal strength of different ranges. However, this is not meant to be a limitation of the present invention. Alternatively, the detection circuit 116 may generate one spatio-temporal data by performing target detection in response to one sensor detection input S_IN provided from the wireless receiver 108. Hence, each spatio-temporal data may give target detection results of different ranges. For example, when an object is detected at a range according to a detection threshold, the spatio-temporal data collected by the detection circuit 116 may have a target detection result of the range that is set by a first logic value (e.g., ‘1’); and when no object is detected at the range according to the detection threshold, the spatio-temporal data collected by the detection circuit 116 may have the target detection result of the range that is set by a second logic value (e.g., ‘0’). To put it simply, the present invention has no limitation on a format of the spatio-temporal data.

As mentioned above, the detection circuit 116 collects the spatio-temporal data D_ST while the fixture 300 on which the object detection apparatus 100 is mounted is moving along one side of the swept area 302 of object detection. In accordance with the proposed signature-based object detection design, the detection circuit 116 stitches/assembles the spatio-temporal data D_ST derived from sensor detection inputs S_IN generated at different positions and different timestamps to create one spatio-temporal image IMG_ST for further processing, where the spatio-temporal image IMG_ST contains signatures (e.g., geometry signatures) of surrounding objects. At step 208, the detection circuit 116 performs signature extraction upon the spatio-temporal image IMG_ST to generate a signature extraction result. At step 210, the detection circuit 116 identifies a contour of the swept area 302 according to the signature extraction result. The contour of the swept area 302 may be represented by continuous signatures (i.e., connected signatures) in the signature extraction result, or may be represented by discontinuous signatures (i.e., unconnected signatures) in the signature extraction result, or may be represented by continuous signatures (i.e., connected signatures) and discontinuous signatures (i.e., unconnected signatures) in the signature extraction result. For example, the signature extraction result may be evaluated for empty space detection. Hence, dimensions of an empty space in the swept area 302 may be determined according to the signature extraction result. That is, location and size of an empty space can be inferred through signatures detected in the spatio-temporal image.

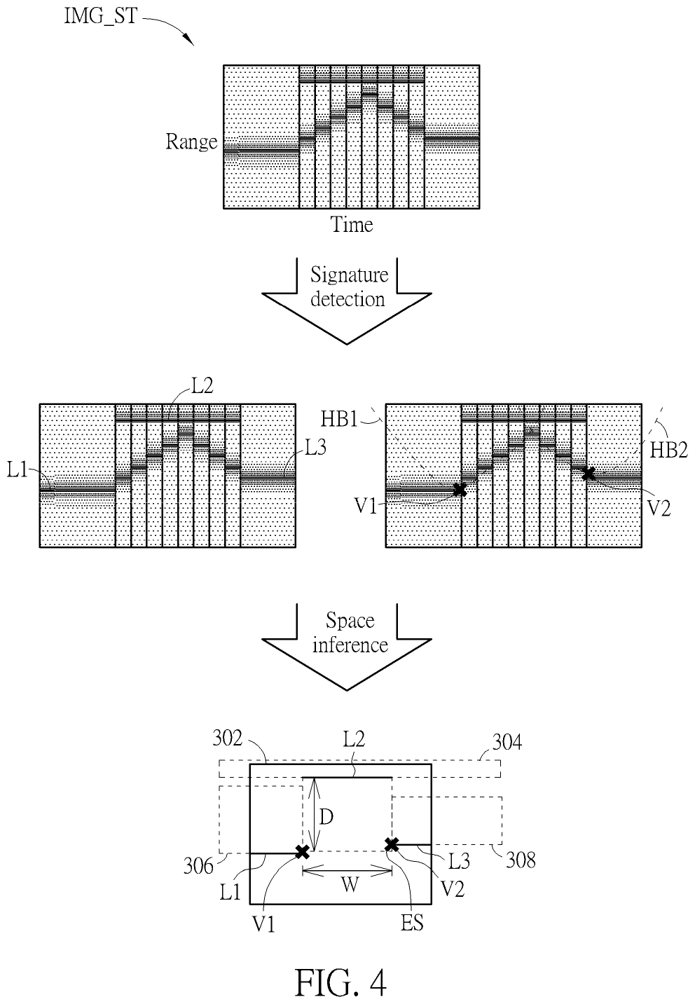

FIG. 4 is a diagram illustrating a data processing scheme for signature-based empty space detection according to an embodiment of the present invention. After the spatio-temporal image IMG_ST is created on the basis of the spatio-temporal data collection as illustrated in FIG. 3, the detection circuit 116 performs signature detection upon the spatio-temporal image IMG_ST. For example, image edge detection and feature extraction techniques may be employed by the signature detection for detecting/extracting signatures in the spatio-temporal image IMG_ST. The signature detection performed by the detection circuit 116 may include detecting existence of at least one hyperbola in the spatio-temporal image IMG_ST, and/or detecting existence of at least one line in the spatio-temporal image IMG_ST. In this embodiment, the spatio-temporal image IMG_ST contains signatures such as hyperbolas HB1 and HB2 and lines L1, L2 and L3. Hence, after the detection circuit 116 performs signature detection upon the spatio-temporal image IMG_ST, the signature detection result includes hyperbolas HB1 and HB2 and lines L1, L2 and L3 that are found in the spatio-temporal image IMG_ST.

Next, the detection circuit 116 performs empty space dimension inference by evaluating the signature detection result. With the help of detected signatures (e.g., hyperbolas and lines), dimensions of possible free space can be reconstructed. For example, vertices of hyperbolas indicate corners or poles, and lines show walls or curbs. Hence, vertices V1 and V2 of the detected hyperbolas HB1 and HB2 can be used to determine a width W of the empty space ES in the swept area 302 of object detection, and the detected lines L1-L3 can be used to determine a depth D of the empty space ES in the swept area 302 of object detection.

In above example, the signature detection result is evaluated for empty space detection. However, this is not meant to be a limitation of the present invention. Any radar sensor based application using a result of applying signature detection to a spatio-temporal image falls within the scope of the present invention.

In one exemplary implementation, the processing circuit 102 may be implemented by dedicated hardware. Hence, each of control circuit 112, modulation circuit 114, and detection circuit 116 is arranged to perform its designated function by using hardware only.

In another exemplary implementation, the processing circuit 102 may be implemented by a processor such as an on-chip microcontroller unit (MCU). Hence, each of control circuit 112, modulation circuit 114, and detection circuit 116 is arranged to perform its designated function by reading a program code PROG from the storage device 104 and running the program code PROG on the processor, where the program code PROG includes processor-executable instruction(s).

In yet another exemplary implementation, the processing circuit 102 may be a hybrid circuit that is implemented by a combination of dedicated hardware and a processor. For example, the control circuit 112 may perform one part of its designated function by using hardware only and may perform another part of its designated function by running the program code PROG on the processor, the modulation circuit 114 may perform one part of its designated function by using hardware only and may perform another part of its designated function by running the program code PROG on the processor, and/or the detection circuit 116 may perform one part of its designated function by using hardware only and may perform another part of its designated function by running the program code PROG on the processor. For another example, at least one of control circuit 112, modulation circuit 114, and detection circuit 116 may perform its designated function by using hardware only, and at least one of control circuit 112, modulation circuit 114, and detection circuit 116 may perform its designated function by reading the program code PROG from the storage device 104 and running the program code PROG on the processor.

The proposed signature-based object detection design takes the advantage of sensor's wide FOV which allows target reflections to form signatures. Hence, the signatures can be used to identify empty spaces in the environment. Compared to an edge detection based object detection design using narrow-FOV sensor(s) for empty space detection, the proposed signature-based object detection design using a single wide-FOV sensor for empty space detection has a lower production cost. Compared to a synthetic aperture radar (SAR) approach based object detection design using a de-convolution process for empty space detection, the proposed signature-based object detection design using a signature extraction process has lower computational complexity. Compared to a grid map approach based object detection design using multiple sensors or multiple antennas for empty space detection, the proposed signature-based object detection design using only a single sensor that is equipped with only a single antenna has a lower production cost.

In some embodiments of the present invention, the proposed signature-based object detection design may be employed by an object detection apparatus using a single narrow-FOV sensor for empty space detection. To put it simply, the proposed signature-based object detection design has no limitations on sensor's FOV. These alternative designs all fall within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An object detection method comprising:
obtaining a plurality of sensor detection inputs generated at different positions and different timestamps for a swept area of object detection, wherein each of the sensor detection input is generated at one of the different locations and one of the different timestamps;
collecting spatio-temporal data according to the sensor detection inputs;
stitching the spatio-temporal data to generate a spatio-temporal image;
performing signature extraction, by a processing circuit, upon the spatio-temporal image to generate a signature extraction result; and
identifying a contour of the swept area according to the signature extraction result.

2. The object detection method of claim 1, wherein collecting the spatio-temporal data comprises:
while a single sensor is moving, collecting the spatio-temporal data for the swept area by using only the single sensor.

3. The object detection method of claim 2, wherein the single sensor is equipped with multiple-object reporting capability.

4. The object detection method of claim 2, wherein the single sensor has only a single antenna.

5. The object detection method of claim 1, wherein the object detection method is employed by a Radio Detection and Ranging (radar) system, and the processing circuit is a part of the radar system.

6. The object detection method of claim 1, wherein performing the signature extraction upon the spatio-temporal image comprises:
detecting existence of at least one hyperbola in the spatio-temporal image.

7. The object detection method of claim 1, wherein performing the signature extraction upon the spatio-temporal image comprises:
detecting existence of at least one line in the spatio-temporal image.

8. The object detection method of claim 1, wherein identifying the contour of the sensor swept area comprises:
referring to the signature extraction result to determine dimensions of an empty space in the swept area.

9. The object detection method of claim 8, wherein the signature extraction result comprises a plurality of hyperbolas, and vertices of the hyperbolas are used to determine a width of the empty space.

10. The object detection method of claim 8, wherein the signature extraction result comprises a plurality of lines, and the lines are used to determine a depth of the empty space.

11. An object detection apparatus comprising:
a wireless receiver, arranged to generate a plurality of sensor detection inputs at different positions and different timestamps for a swept area of object detection, wherein each of the sensor detection input is generated at one of the different locations and one of the different timestamps; and
a processing circuit, arranged to obtain the sensor detection inputs, collect spatio-temporal data according to the sensor detection inputs, stitch the spatio-temporal data to generate a spatio-temporal image, perform signature extraction upon the spatio-temporal image to generate a signature extraction result, and identify a contour of the swept area according to the signature extraction result.

12. The object detection apparatus of claim 11, wherein the object detection apparatus is a single sensor; and while the single sensor is moving, the processing circuit of the single sensor collects the spatio-temporal data for the swept area by using only the sensor detection inputs obtained by the wireless receiver of the single sensor.

13. The object detection apparatus of claim 12, wherein the single sensor is equipped with multiple-object reporting capability.

14. The object detection apparatus of claim 12, wherein the single sensor has only a single antenna.

15. The object detection apparatus of claim 11, wherein the object detection apparatus is a Radio Detection and Ranging (radar) system.

16. The object detection apparatus of claim 11, wherein the signature extraction comprises detecting existence of at least one hyperbola in the spatio-temporal image.

17. The object detection apparatus of claim 11, wherein the signature extraction comprises detecting existence of at least one line in the spatio-temporal image.

18. The object detection apparatus of claim 11, wherein the processing circuit refers to the signature extraction result to determine dimensions of an empty space in the swept area.

19. The object detection apparatus of claim 18, wherein the signature extraction result comprises a plurality of hyperbolas, and vertices of the hyperbolas are used by the processing circuit to determine a width of the empty space.

20. The object detection apparatus of claim 18, wherein the signature extraction result comprises a plurality of lines, and the lines are used by the processing circuit to determine a depth of the empty space.
